(19) United States
(12) Patent Application Publication
(10) Pub. No.: US 2009/0251483 A1
(43) Pub. Date: Oct. 8, 2009

(54) METHOD AND RELATED CIRCUIT FOR COLOR DEPTH ENHANCEMENT OF DISPLAYS

(75) Inventors: CHING-HSIANG HSU, Taipei (TW); LING-CHIH LU, Hsinchu (TW); TANG-WEI CHEN, Taipei (TW)

Correspondence Address: WPAT, PC, 7225 BEVERLY ST., ANNANDALE, VA, 22003, US

(73) Assignee: FARADAY TECHNOLOGY CORPORATION, Hsinchu (TW)

(21) Appl. No.: 12/417,275

(22) Filed: Apr. 2, 2009

(30) Foreign Application Priority Data
Apr. 3, 2008 (TW) 097112244

(51) Int. Cl. G09G 5/02

(52) U.S. Cl. 345/589

(57) ABSTRACT

Method and related circuit for color depth enhancement of displays is provided. In an embodiment of the invention, when emulating an interpolated color level between a first and a second color levels the display can display, a color channel component of the first color level and another color channel component of the second color level are selected for color dithering and color depth enhancement.

### FIELD OF THE INVENTION

The present invention relates to a method and related circuit for color depth enhancement of displays, and more particularly, to a method and related circuit for color depth enhancement using alternating components of different color channels.

### BACKGROUND OF THE INVENTION

Displays, especially liquid crystal displays (LCD's), are one of the most important human-machine interfaces of modern information system. Thus, how to enhance display functions of displays has become a technology development key point of modern information system designers and vendors.

As known by those skilled in art, color display capability of a display panel (like an LCD panel) in a display is usually presented as number of bits of displayable color levels. For example, a 6-bit display panel means that the display panel can display 2̂6 (=128) different levels in each of red, green and blue channels, i.e., a 6-bit display panel can display 2̂18 different color levels in total. 6-bit display panels have competitive advantage in prices, so they are widely adopted.

However, modern information system is preferred to have 8-bit color level display capability (i.e., 2̂8 different levels in each of red, green and blue channels, 2̂24 different color levels in total) for demonstrating fine, rich and detailed images. Therefore, some prior art techniques have been developed to emulate high-bit color displaying with low-bit display panel (e.g., to emulate 8-bit color levels on a 6-bit display panel), wherein such techniques are usually referred to as color depth enhancement. US patents such as U.S. Pat. Nos. 5,677,704, 5,712,651, 5,929,350, 7,030,846, 5,920,350 and 7,176,867 mention about various color depth enhancement techniques.

Please refer to FIG.1 which illustrates a color depth enhancement technique mentioned in U.S. Pat. No. 5,920,350. In FIG. 1, a display panel is assumed to be capable of displaying two color levels (r0, g0, b0) and (r1, g1, b1) with r0 and r1 being red channel components, g0 and g1 being green channel components, and b0 and b1 being blue channel components. To enhance color depth between these two color levels by displaying an interpolated color level ((R0+r1)/2, (g0+g1)/2, (b0+b1)/2) dithered in neighboring four pixels, the prior art, in an alternating manner, displays color levels (r0, g0, b0) and (r1, g1, b1) in different times (frames) and locations (pixels). Thus, a color level ((r0+r1)/2, (g0+g1)/2, (b0+b1)/2) originally not being displayable can be emulated with temporal and spatial integration of human eye. Similarly, the prior art can emulate color levels ((3*r0+r1)/4, (3*g0+g1)/4, (3*b0+b1)/4) and ((r0+3*r1)/4, (g0+3*g1)/4, (b0+3*b1)/4). According to similar concept, another prior art (such as mentioned in U.S. Pat. No. 7,176,867) depicted in FIG. 2 emulates a dithered color level ((r0+r1)/2, (g0+g1)/2, (b0+b1)/2).

However, the aforementioned prior arts have similar disadvantages. While enhancing color depth between two displayable color levels (r0, g0, b0) and (r1, g1, b1), those arts directly display the two extreme color levels (r0, g0, b0) and (r1, g1, b1) in an alternating manner; since the two color levels (r0, g0, b0) and (r1, g1, b1) have large mutual contrast, a smooth and natural color dithering is difficult to achieve. Also, while those arts use regularly repeated alternating temporal and spatial patterns to display the two extreme color levels for color dithering, the regularly repeated patterns often demonstrate uncomfortable flickers in human vision. For example, in FIG. 2, regularly repeated patterns of alternating extreme color levels in both temporal and spatial domains will cause microscopic oblique line patterns tilted in alternating directions, which is difficult to achieve a steady and comfortable color dithering and color depth enhancement.

### SUMMARY OF THE INVENTION

It is therefore one of the objectives of the present invention to provide a better color depth enhancement technique for a display to avoid disadvantages of prior arts. The display is capable of displaying different color levels (displayable color levels) with each color level having components of respective color channels (like red, green and blue channels). An input color level desired to be displayed on the display has different data of respective color channels. As previously discussed, the bit-depth (number of bits) a display can display may be less than the bit-depth of the input color level. If the input color level not directly displayable on the display falls between a first displayable color level and a second displayable color level, an output color level displayable on the display is provided by selecting a first color channel component of the first displayable color level and a second color channel component of the second displayable color level. To be more specific, the first color channel component of the first displayable color is assigned to the first color channel data of the output color level, and the second color channel component of the second displayable color is assigned to the second color channel data of the output color level. And this displayable output color level is used (e.g., is displayed on the display) for color dithering to emulate the input color level originally not displayable on the display.

For example, in an embodiment of the invention, if the first and second displayable color levels are respectively (r0, g0, b0) and (r1, g1, b1), the present invention achieves color depth enhancement by using (displayable) output color levels such as (r0, g1, b0), (r0, g1, b1), (r0, g0, b1), (r1, g0, b1), (r1, g0, b0) and/or (r1, g1, b0) to emulate color levels between the first and second displayable color levels, where the color level (r0, g1, b0) is formed by selecting red and blue channel components from the first displayable color level and by selecting green channel component from the second displayable color level. Similarly, the color level (r1, g0, b1) is formed by selecting red (and blue) channel component of the second displayable color level and by selecting green channel component of the first displayable color level. Because these color levels (r0, g1, b0), (r0, g1, b1), (r0, g0, b1), (r1, g0, b1), (r1, g0, b0) and (r1, g1, b0) have less mutual contrast comparing to the two extreme displayable first and second color levels (r0, g0, b0) and (r1, g1, b1), a smooth, soft and natural color dithering is achieved while performing color depth enhancement, and the disadvantage of prior arts by just using the two extreme displayable color levels can therefore be reduced or avoided.

While enhancing color depth, in addition to the color levels (r0, g1, b0), (r0, g1, b1), (r0, g0, b1), (r1, g0, b1), (r1, g0, b0) and (r1, g1, b0), the original first and second color levels (r0, g0, b0) and (r1, g1, b1) can also be adopted by the present invention for variations of color dithering.

To control orders and patterns of color dithering in temporal and spatial domains, the present invention utilizes a specific temporal/spatial pattern to control output color levels of each pixel in different frames as well as output color levels of neighboring (or adjacent) pixels in a same frame. For example, assuming a pixel has an input color level between a darker first displayable color level (r0, g0, b0) and a brighter second displayable color level (r1, g1, b1) in a frame and a color level (r0, g1, b0) is selected as a dithered output color level, if in a second frame the pixel is of an input color level between a darker third displayable color level (r2, g2, b2) and a brighter fourth color level (r3, g3, b3), then a color level (r3, g2, b3) can be selected as the dithering output color level for this second frame. That is, in a former frame, if a darker red channel component a brighter green channel component of the first and second displayable color levels are respectively selected for dithering, and then in a latter frame an opposite selection (pattern) is adopted to select a darker green channel component and a brighter red channel component respectively from the third and fourth displayable color levels for dithering. Of course, one of the third and fourth displayable color levels can be selected as an output color level for a latter frame according to selection made in a former frame.

Similarly, for neighboring pixels of a same frame, dithering selection for a pixel can be decided according to that made for an adjacent pixel. For example, opposite color component selections can be applied to two adjacent pixels on a same frame. Such selection technique of the present invention can effectively reduce visual discomfort caused by pixels turning brighter or darker together in temporal and/or spatial domains.

Another objective of the present invention is providing a method to implement aforementioned color depth enhancement of the present invention. For a display capable of receiving images of different frames and displaying different displayable color levels with each displayable color level having components of different color channels, each frame including a plurality of scan lines, each scan line including a plurality of pixels and each pixel corresponding to an input color level which has a plurality of data respectively corresponding to the color channels, the method includes: while sequentially receiving input color levels of pixels of each frame, providing a pixel value for each pixel according to which scan line each pixel corresponds to and where each pixel locates in corresponding scan line; providing an LUT (Look-Up Table), and performing the followings for each pixel: selecting a first displayable and a second displayable color levels among the displayable color levels for each pixel according to corresponding input color level of each pixel, selecting a first color channel and a second color channel for each pixel according to the LUT and corresponding pixel value of each pixel, and providing an output color level for each pixel such that the first color channel component of the first displayable color is assigned to the first color channel data of the output color level, and the second color channel component of the second displayable color level is assigned to the second color channel data of the output color level.

Wherein when providing corresponding pixel value and selecting color channels for each pixel includes: as images are transmitted, counting which frame each pixel corresponds to, which scan line each pixel corresponds to and where each pixel locates in corresponding scan line to respectively provide a period count, a line count and a pixel count for each pixel; and providing a frame count, a line value and the pixel value for each pixel respectively according to corresponding period count, line count and pixel count of each pixel. Wherein if corresponding period count of a pixel matches a predetermined condition (like a predetermined value), a stochastically generated random number is used to reset corresponding frame count of the pixel. Also, if corresponding line count of a pixel matches another predetermined condition (like another predetermined value), another stochastically generated random number is provided to reset corresponding line value of the pixel. Corresponding pixel value of each pixel is decided according to corresponding line value and pixel count of each pixel.

In addition, a region code is provided for each pixel according to corresponding line count and pixel count of each pixel, and an interpolation code is provided for each color channel of each pixel according to corresponding input color level of each pixel. The LUT provides LUT values respectively corresponding to different frame counts, different region codes and different interpolation codes. Selecting of corresponding color channels (e.g., the first and second color channel) and selecting of displayable color levels (e.g., the first and second displayable color levels) for each pixel include: finding an LUT value for each color channel of each pixel according to corresponding frame count of each pixel, region code of each pixel and interpolation code of each color channel of each pixel, providing a sum for each color channel of each pixel according to corresponding LUT value and pixel value, summing corresponding sum and interpolation code of each color channel of each pixel and then making selections according to summations respectively summing corresponding sum and interpolation code of each color channel of each pixel.

Basically, line values and pixel values are used to control spatial pattern of color channel selection; with help of LUT values corresponding to frame counts in temporal domain, color channel selection for each pixel is determined. Because line values (as well as pixel values) and frame counts are provided with stochastic nature, a random temporal dithering order and a random spatial dithering pattern are introduced in color dithering of the present invention, such that visual discomfort and artifacts caused by regular (and deterministic) dithering patterns of prior arts can be reduced and/or avoided.

Still another object of the invention is providing a color depth enhancement circuit for a display. In an embodiment, the color depth enhancement circuit is installed in a timing control circuit of a display. The color depth enhancement circuit of the present invention includes a spatial pattern generator, an LUT circuit and an adjust circuit. While sequentially receiving input color levels of pixels of frames, the spatial pattern generator provides a pixel value for each pixel according to which scan line each pixel corresponds to and where each pixel locates in corresponding scan line. The LUT circuit provides an LUT. The adjust circuit selects a first color level and a second color level among the displayable color levels of the display for each pixel according to corresponding input color level of each pixel, and selects a first color channel and a second color channel for each pixel according to the LUT and corresponding pixel value of each pixel, such that an output color level for each pixel can be provided by assigning the first color channel component of the first color level to the first color channel data of the output color level and assigning the second color channel component of the second color level to the second color channel data of the output color level.

To be more specific, the spatial pattern generator of the present invention can include a period counter, a line counter and a pixel counter for respectively providing a period count, a line count and a pixel count for each pixel according to which frame each pixel corresponds to, which scan line each pixel corresponds to and where each pixel locates in corresponding scan line. Also a frame counter, a line value circuit, a pixel value circuit and a random number generator are included for respectively providing a frame count, a line value and the pixel value for each pixel according to corresponding period count, line count and pixel count of each pixel. The color depth enhancement circuit also provides a region code for each pixel according to corresponding line count and pixel count of each pixel.

The adjust circuit includes a data mapping circuit and an adder. The data mapping circuit calculates an interpolation code for each color channel of each pixel according to corresponding input color level of each pixel. The LUT circuit provides LUT values respectively for different frame counts, region codes and interpolation codes. According to corresponding LUT value of each color channel of each pixel and pixel value of each pixel, a sum for each color channel of each pixel is provided by the adder, thus the adjust circuit can select combinations of color channels and displayable color levels for each pixel accordingly to achieve color depth enhancement of the present invention.

### BRIEF DESCRIPTION OF THE DRAWINGS

The above objects and advantages of the present invention will become more readily apparent to those ordinarily skilled in the art after reviewing the following detailed description and accompanying drawings, in which:

FIGS. 1 and 2 respectively illustrate color depth enhancement by color dithering of prior arts;

FIG. 3 shows differences in color depth enhancement between prior art and present invention;

FIG. 4 is a block diagram showing a color depth enhancement circuit of the present invention set in a display system;

FIG. 5 is a block diagram showing an embodiment of the color depth enhancement circuit in FIG. 4 according to the present invention;

FIG. 6 illustrates timing relation among various counts and values in FIG. 5;

FIG. 7 illustrates an embodiment for obtaining the counts and values in FIG. 5;

FIG. 8 shows an exemplary temporal order of the frame count and period count in FIG. 5;

FIG. 9 demonstrates an exemplary distribution of pixel counts, pixel values, line counts and line values in a frame;

FIG. 10 further shows an exemplary distribution of pixel values in a frame following the example in FIG. 9;

FIG. 11 shows a mapping embodiment for the region code in FIG 5;

FIGS. 12-15 abstract an embodiment for an LUT provided by the LUT circuit of FIG. 5;

FIG. 16 demonstrates an embodiment for calculating an output color level corresponding to an input color level of FIG. 5;

FIGS. 17 and 18 illustrate exemplary spatial and temporal patterns for component selection for each color channel of each pixel following FIG 7 and FIG. 16; and

FIGS. 19 and 20 depict examples of color depth enhancement by color dithering of the present invention following the examples in FIGS. 17 and 18.

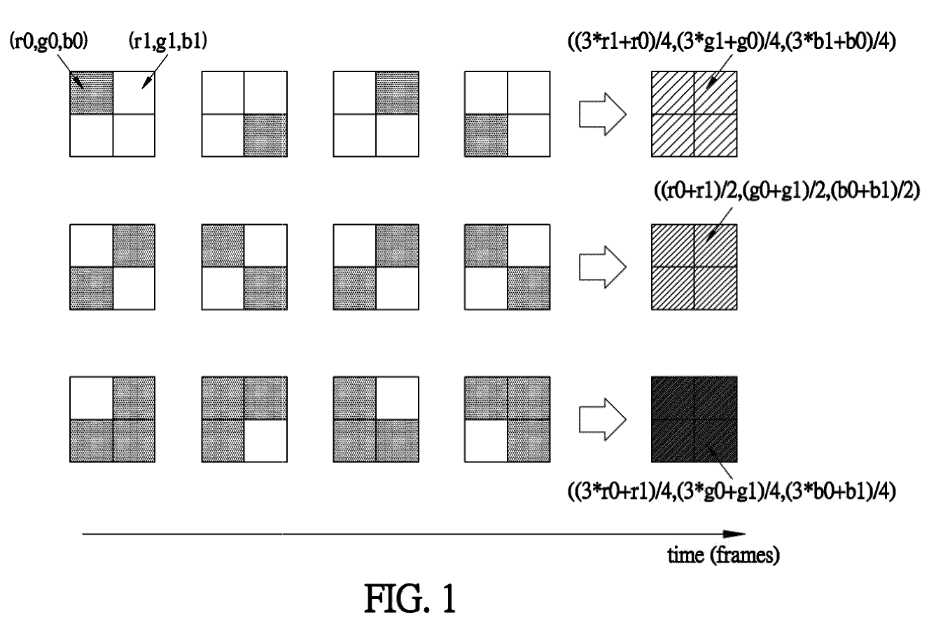

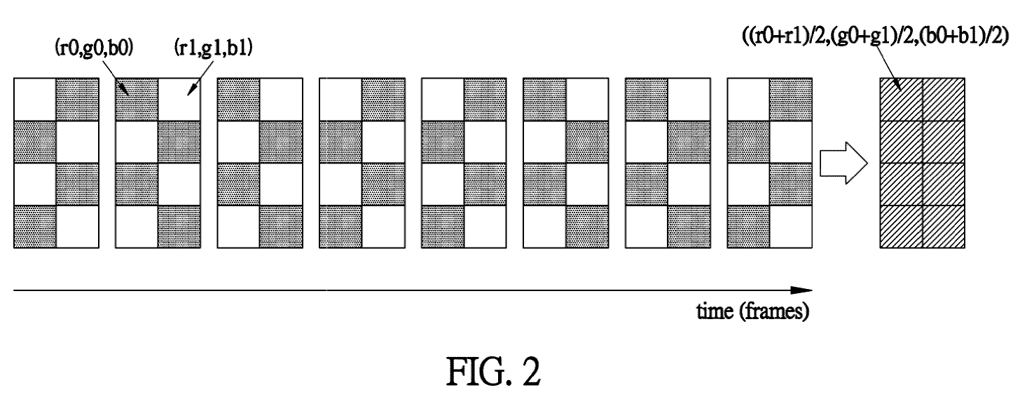

### DETAILED DESCRIPTION OF THE PREFERRED EMBODIMENT

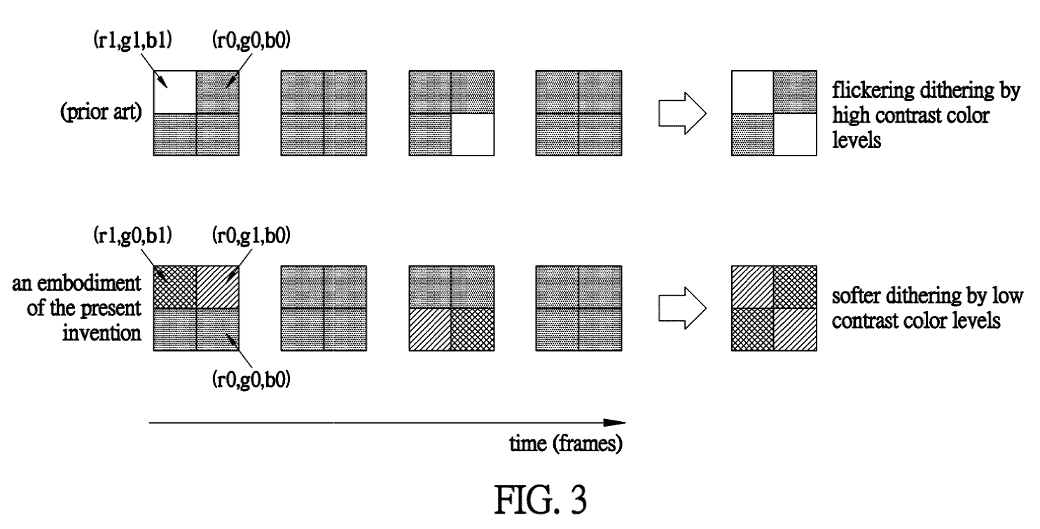

Please refer to FIG. 3 which depicts an exemplary embodiment to illustrate technique and advantage of the present invention comparing to prior art. As previously discussed, assuming a display/display panel can display two (displayable) color levels (r0, g0, b0) and (r1, g1, b1), a prior art directly displays these two color level in alternating manner to emulate a color level not displayable, as shown in upper portion of FIG. 3. On the other hand, in one embodiment of the invention, color levels (r0, g1, b0), (r1, g0, b1) and (r0, g0, b0) are adopted for color depth enhancement (though color level (r1, g1, b1) can also be used, as detail will be discussed later), as shown in lower portion of FIG. 3. The prior art and the invention both emulate a color level not displayable (a color level (3*r0+r1)/4, (3*g0+g1)/4, (3*b0+b1)/4) in the example of FIG. 3). However, since the prior art uses two extreme color levels (r0, g0, b0) and (r1, g1, b1) which have large mutual contrast for color dithering, it easily causes visual flicker in both temporal and spatial domains. On the contrary, the invention selects components of different color channels from different color levels (r0, g0, b0) and (r1, g1, b1) to form the color levels (r0, g1, b0) and (r1, g0, b1); together with original extreme color levels (r0, g0, b0) and/or (r1, g1, b1), these color levels are adopted for color depth enhancement. Because these color levels (r0, g0, b0), (r0, g1, b0), (r1, g0, b1) and/or (r1, g1, b1) have less mutual contrast, color dithering of the present invention is smother, softer and more natural in human vision. Not only the invention emulates color levels originally not displayable, but also the invention achieves color depth enhancement with better visual comfort.

In addition to dithering color with color levels of less contrast, the invention alternates color dithering patterns stochastically in both temporal and spatial domains, such that a user of the display senses less flickers caused by predictably periodic and regular dithering patterns. A more detailed embodiment will be described as follows.

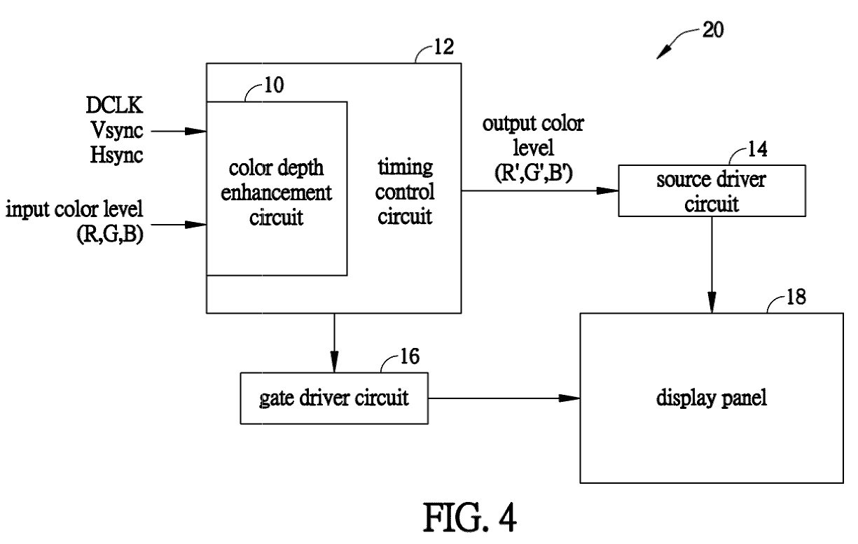

Please refer to the block diagram shown in FIG. 4, which depicts a color depth enhancement circuit 10 according to the invention applied in a display 20. The display 20 can be a display device like an LCD display or an LCD television, which includes a timing control circuit 12, a source driver circuit 14, a gate driver circuit 16 and a display panel 18 (such as an LCD panel). The display 20 receives external video images which are transmitted with a clock DCLK, a horizontal synchronization signal Hsync and a vertical synchronization signal Vsync, such that color channel components (R, G, B) of each pixel of the images can be inputted to the timing control circuit 12, and then the timing control circuit 12 can accordingly provide corresponding output color level (R′, G′, B′) for each input color level (R, G, B), and other control signals (not shown in FIG. 4) to control the source driver circuit 14 and the gate driver circuit 16. The source driver circuit 14 and the gate driver circuit 16 will drive display units (e.g., pixels, like LCD display units) to demonstrate video images. The color depth enhancement circuit 10 of the present invention can be integrated in the timing control circuit 12 to calculate the output color level (R′, G′, B′) for each pixel according to clock/signals DCLK, Hsync, Vsync and the input color level (R, G, B). With displaying of the output color level (R′, G′, B′), color depth enhancement is achieved by emulating high-bit color levels on a display of low-bit color levels.

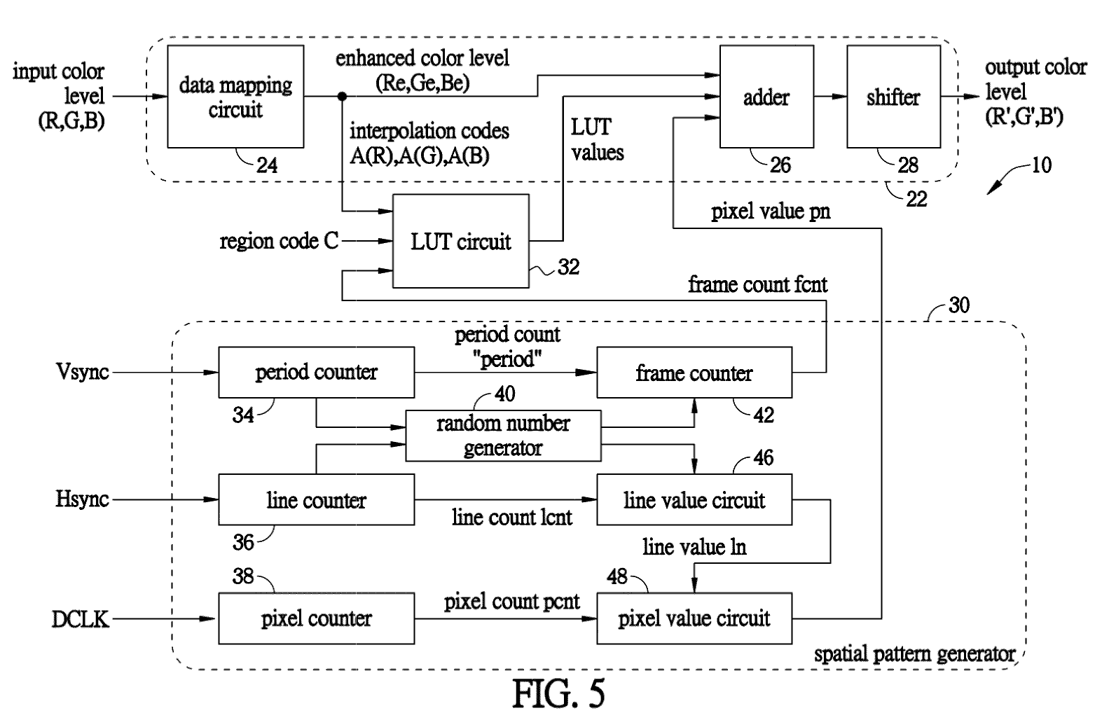

Following the embodiment of FIG. 4, please refer to FIG. 5. FIG. 5 illustrates a block diagram of the color depth enhancement circuit 10 according to an embodiment of the present invention. The color depth enhancement circuit 10 of the invention includes an adjust circuit 22, an LUT circuit 32 and a spatial pattern generator 30. The spatial pattern generator 30 includes a period counter 34, a line counter 36, a pixel counter 38, a random number generator 40, a frame counter 42, a line value circuit 46 and a pixel value circuit 48. The period counter 34 counts a period count (labeled as “period” in FIG. 5) according to the vertical synchronization signal Vsync, so the frame counter 42 can provide a frame count fcnt according to the period count “period” and operations of the random number generator 40. The line counter 36 counts a line count lcnt according to the horizontal synchronization signal Hsync, such that the line value circuit 46 can provide a line value ln according to the line count lcnt and operations of the random number generator 40. In addition, the pixel counter 38 counts a pixel count pcnt according to the pixel clock DCLK, and then the pixel value circuit 48 provides a pixel value pn according to the line value ln and the pixel count pcnt. Also, the color depth enhancement 10 provides a region code C according to the line count lcnt and the pixel count pcnt.

On the other hand, the adjust circuit 22 includes a data mapping circuit 24, an adder 26 and a shifter 28. The data mapping circuit 24 provides an enhanced color level (Re, Ge, Be) according to corresponding input color level (R, G, B), also provides corresponding interpolation codes A(R), A(G) and A(B) for each color channel. Then the LUT circuit 32 finds a set of LUT values for each combination of interpolation code A, region code C and frame count fcnt. According to corresponding set of LUT values and pixel value pn, a sum (not shown in FIG. 5) is calculated for each color channel, and the adder 26 respectively sums up corresponding sum of each color channel and each color channel component of the enhanced color level (Re, Ge, Be) to output result to the shifter 28, and then the shifter 28 generates corresponding output color level (R′, G′, B′) accordingly.

In an embodiment of the invention, input color level (R, G, B) can be 8-bit color level (i.e., 8-bit component in each color channel), and the display panel 18 is of 6-bit. The invention first expands the 8-bit input color level to a corresponding 10-bit color level (e.g., the enhanced color level), that is, the expanded color level has 10-bit component in each color channel. A corresponding 4-bit interpolation code A is calculated for each color channel according the expanded 10-bit component, and then the adder 26 and the shifter 28 provide corresponding 6-bit output color level (R′, G′, B′) with 6-bit component data in each color channel, such that the 6-bit output color level (R′, G′, B′) can be displayed on the 6-bit display panel 18.

While expanding the 6-bit input color level to corresponding 10-bit enhanced color level, each 8-bit binary component of the input color level is first left shift by one bit and then a bit of value 0 is filled in LSB (Least Significant Bit) of the shifted result to form a 9-bit value M1. Then the value M1 is right shifted by 6 bits to form a 3-bit value M2, also the value M1 is right shifted by 8 bits to form a 1-bit value M3. Finally, (M1−M2+M3) is calculated; and the result is left shifted by one bit and is filled with a bit of value 0 in LSB to form (a corresponding component of) the expanded 10-bit color level, and the least significant 4 bits of each color channel component of the expanded 10-bit color level become corresponding interpolation code for each color channel. For example, assuming a color channel component data of an input color level is binary 11111101, so the corresponding value M1 is binary 111111010, value M2 is binary 111, value M3 is 1, therefore (M1−M2+M3) is calculated to be binary 111110100, and it is left shifted to obtain an expanded 10-bit binary component 1111101000, and a corresponding binary interpolation code A is extracted from the least significant four bits to be binary 1000.

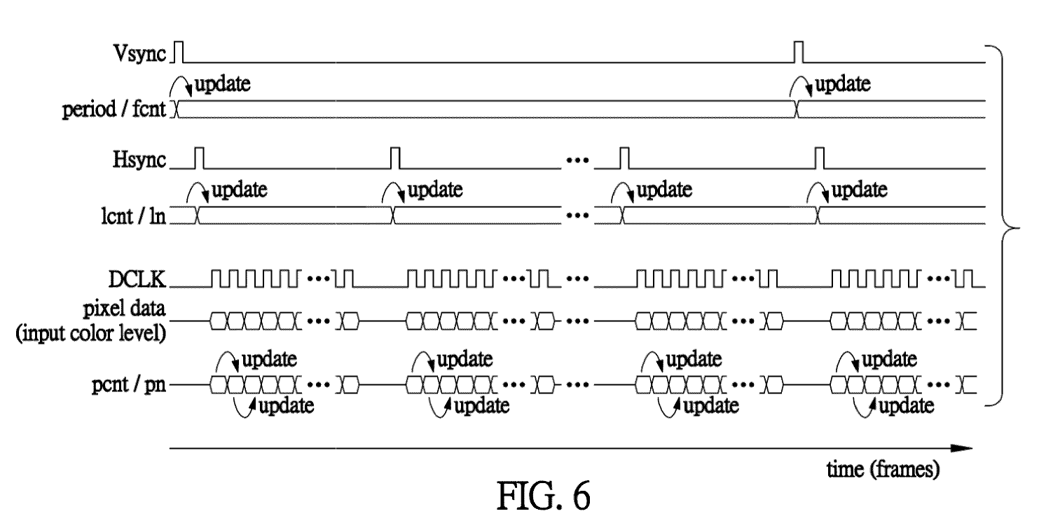

Operation of the spatial pattern generator 30 can be further described as follows. Please refer to FIG. 6 which illustrates a timing diagram to show how the period count “period”, frame count fcnt, line count lcnt, line value ln, pixel count pcnt and pixel value pn update with the signals Vsync and Hsync and the clock DCLK. As well understood, pixel data (e.g., input color level of each pixel) of each scan line of each frame of the video images will be transmitted in coordinate with the horizontal synchronization signal Hsync, the vertical synchronization signal Vsync and the pixel clock DCLK. Triggering of the signal Vsync reflects transmission of a new frame, the signal Hsync reflects transmission of scan lines and the clock DCLK reflects transmission of pixel data. In the spatial pattern generator 30 of the invention, period count “period” and frame count fcnt will update with triggering of the signal Vsync, line count lcnt and line value ln update with triggering of Hsync, pixel count pcnt and pixel value pn update with each pixel data. In other words, each pixel with a pixel data (e.g., input color level) owns its corresponding pixel count pcnt and a pixel value pn, but pixels corresponding to a same scan line will share a same line count lcnt and a same line value ln, and pixels corresponding to a same frame will share a common period count “period” and a common frame count fcnt.

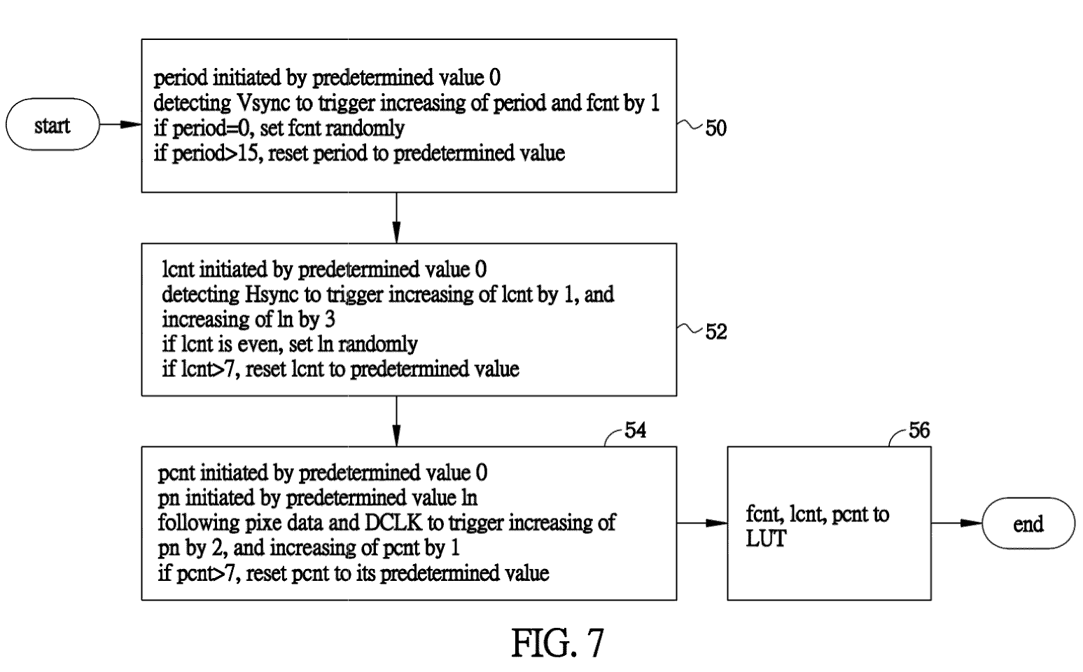

The aforementioned counts and values are updated following an exemplary rule shown in FIG. 7. In FIG. 7, step 50 describes how frame count fcnt and period count “period” update. In the embodiment of FIG. 7, each of period count “period” and frame count fcnt is a 4-bit binary count value. The period count “period” initiates with an initial value (a predetermined value) 0, and is increased by 1 with each triggering of the signal Vsync. When the period count is greater than decimal 15 (i.e., when the 4-bit period count is larger than binary 1111), it is reset to 0, its predetermined value. Meanwhile, the frame count fcnt also increases by one with each triggering of the signal Vsync, but the frame count fcnt will be assigned randomly when the period count becomes 0. For example, the random number generator 40 shown in FIG. 5 can stochastically select (generate) a random number between decimal 0 and 15 to be the frame count fcnt.

Step 52 of FIG. 7 describes how line count lcnt and line value ln are updated. In the embodiment of FIG. 7, the line count lcnt is a 3-bit binary count value, and the line value ln is a 2-bit count value. The line count lcnt initiates with a predetermined value 0, and increases by 1 with each triggering of the signal Hsync. Meanwhile, the line value ln increases by 3 with each triggering of the signal Hsync. However, when the line count lcnt is of an even value (or equivalently, LSB of the line count is 0), the line value ln will be reset randomly. For example, the random number generator 40 can stochastically select (generate) a random number between 0 and 3 (since the line value is of 2-bit) as the line value ln. When the 3-bit line count lcnt becomes greater than decimal 7 (binary 111), the line count lcnt is reset to its predetermined value 0.

In FIG. 7, step 54 describes counting rules for the pixel count pcnt and the pixel value pn. In this embodiment, the pixel count pcnt is a 3-bit binary count value, and the pixel value pn is a 2-bit binary count value. The pixel count pcnt initiates with a predetermined value 0 and increases by 1 with each transmission of a pixel data of a pixel. The pixel value pn initiates with a predetermined value equal to corresponding line value ln, and the pixel value increases by 2 with each transmission of a pixel data of a pixel. Generally speaking, transmission of pixel data follows timing of the clock DCLK and a data enable signal DE (not shown), so the pixel count pcnt and the pixel value pn can be updated with triggering of the signal DE and the clock DCLK. When the pixel count pcnt become greater than decimal 7 (binary 111), the pixel count pcnt will be reset to its predetermined value. In step 56, the counts pcnt, lcnt and fcnt can be outputted to the LUT circuit of FIG. 5.

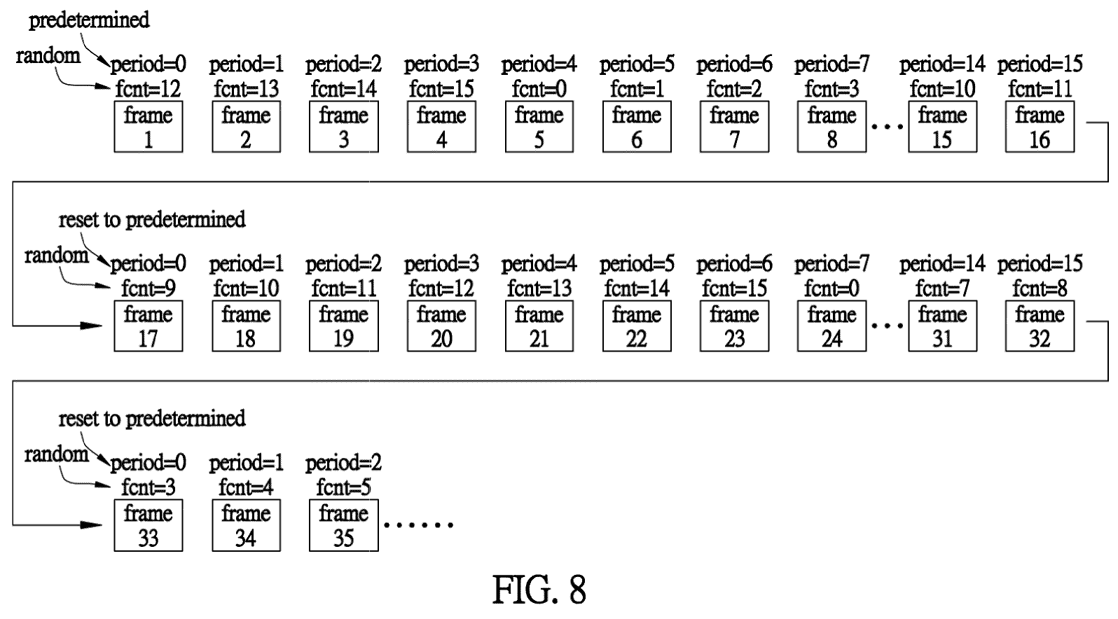

Following the embodiment of FIG. 7, please refer to FIGS. 8, 9 and 10. FIG. 8 illustrates how the period count “period” and the frame count fcnt update with different frames. For example, in frame 1, the period count “period” starts from 0; accordingly, the frame count fcnt is randomly set (to be decimal 12 in the example of FIG. 8). As sequentially transmission of each frame, the period count and the frame count fcnt both increase by 1, wherein the 4-bit frame count fcnt is reset to 0 because of overflow between frame 4 and frame 5. In frame 16, the period count counts up to decimal 15, so it is reset to zero in frame 17. Accordingly, the frame count fcnt is randomly set (to be decimal 9 in this example) again. The period count and the frame count fcnt update following each frame and be reset to 0 when overflow occurs. From FIG. 8, it is understood that 16 frames can be considered as a cycle, e.g., frame 1 to frame 16 is a cycle; frame 17 to frame 32 is another cycle. In each cycle, the frame count fcnt starts a randomly initiated 0-to-15 counting cycle. The stochastic behavior of the frame count fcnt controls temporal dithering pattern of the invention, therefore flickers and discomfort caused by regular (deterministic) temporal dithering pattern of prior arts can be reduced or avoided.

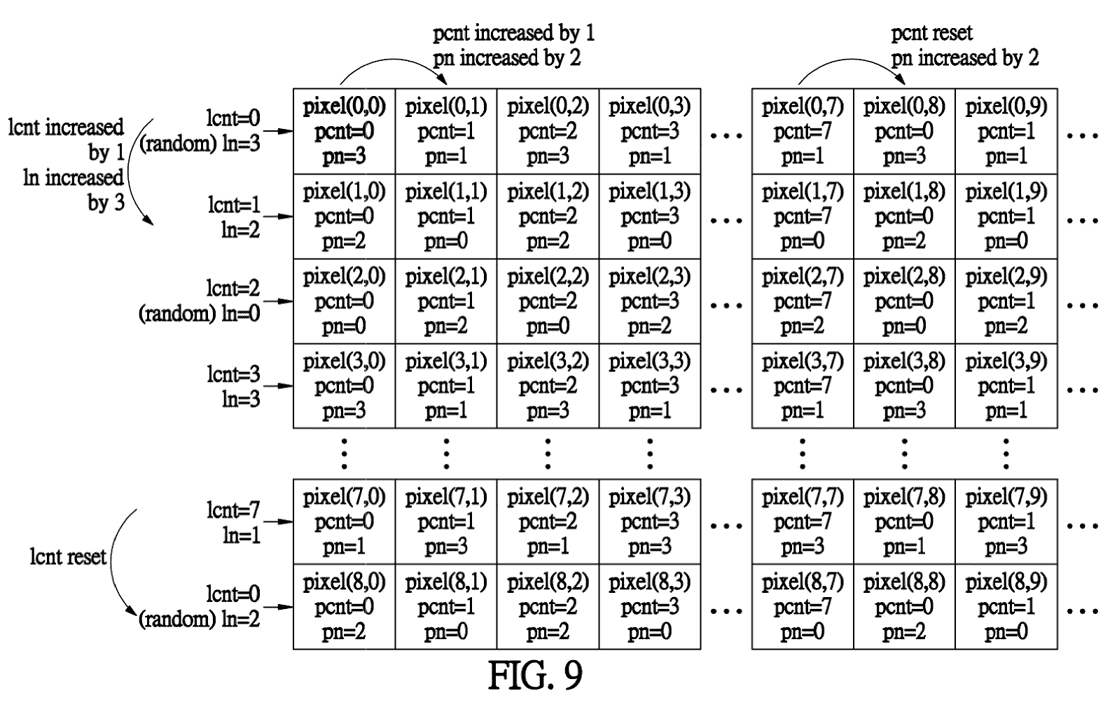

FIG. 9 illustrates distribution of the line count lent, line value ln, pixel count pcnt and pixel value pn in a same frame. For a scan line where pixel (0, 0) to pixel (0, 9) locate, the line count lent is of a predetermined value 0 (an even number), accordingly the line value ln is randomly selected (to be decimal 3 in this example). For the next scan line (where pixel (1, 0) to pixel (1, 9) locate), the line count lent increases by 1, and the line value ln increased by 3 to become decimal 2 because of overflow when the 2-bit line value ln increases by 3 from the original value 3. Continuing to the next scan line where pixels (2, 0) to (2, 9) locate, the line count lent increases by one to become even again, so the line value ln is randomly reset (to 0 in this example) again. As the same update rule applies, when the 3-bit line count lent increased to decimal 7 (binary 111) for the scan line where pixels (7, 0) to (7, 9) locate, it will be reset to 0 again for the next scan line. And the line value ln will be randomly updated as the line count lent alternates between even and odd.

For a same scan line (such as that where pixels (0, 0) to (0, 9) locate), the 3-bit pixel count pcnt increases by 1 from 0 following each pixel, and is reset to 0 again when overflow occurs. For example, the pixel count pcnt corresponding to pixel (0, 0) is 0, and it is increased to be 1 for next pixel (0, 1) on the same scan line. For pixel (0, 7), the pixel count pent counts up to decimal 7, and then it is reset to 0 for next pixel (0, 8).

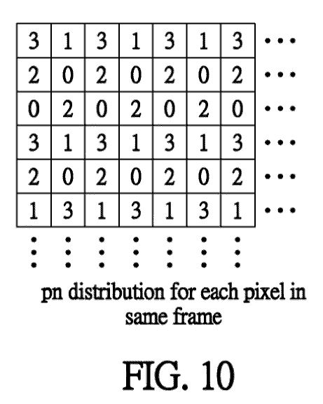

On the other hand, the pixel value pn for each pixel of the same scan line initiates from corresponding line value ln with an increment of 2. As an example, for pixels (0, 0) to (0, 7), the pixel value pn of pixel (0, 0) is decided according to corresponding line value ln, that is decimal 3 in this example. The 2-bit pixel value pn of pixel (0, 1) increases by 2 to be decimal 1 because of overflow. Similarly, for pixels (1, 0) to (1, 7), the pixel value pn of pixel (1, 0) equals corresponding line value ln, which is 2. For the next pixel (1, 1) of the same scan line, corresponding pixel value pn increases by 2 to be 0. Therefore it can be understood that the pixel value will inherit stochastic nature of the line value ln, and the pixel value of each pixel will randomly distributed in spatial domain (i.e., among pixels of a same frame), as shown in FIG. 10. Random distribution of pixel value pn controls spatial dithering pattern of the invention to reduce and/or avoid visual discomfort caused by regular (deterministic) spatial dithering pattern of prior arts.

In addition to form random spatial pattern, the spatial pattern generator 30 of the present invention has another advantage: it does not require massive memory space for recording of temporal and spatial dithering patterns. From aforementioned description, it is understood that the temporal and spatial dithering pattern, respectively represented by the temporal order of the frame count fcnt and the spatial distribution of the pixel value pn, can be generated by merely counting the period count, the line count and the pixel count following transmission of each pixel. Since the invention does not have to adopt a memory to record spatial and temporal dithering patterns for each pixel, hardware resource, circuit complexity, power consumption and layout area of the timing control circuit according to the invention can be effectively reduced.

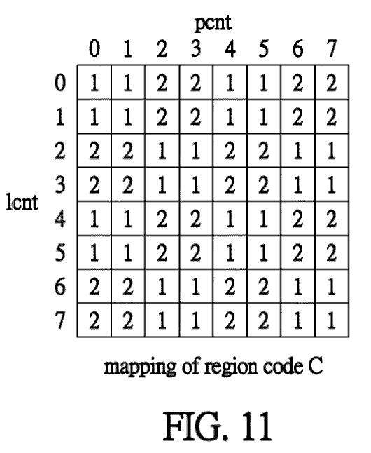

Please refer to FIG. 11 which depicts an embodiment to decide the region code C for each pixel according to corresponding line count lcnt and pixel count pcnt of each pixel. As listed in FIG. 11, if a pixel corresponds to a pixel count pent of decimal value 0, 1, 4 or 5 and a line count lent of decimal value 0, 1, 4 or 5, then the pixel is mapped to a region code C of value 1; otherwise the pixel is mapped to a region code C of value 2. Please refer back to FIG. 5 again. With the aforementioned frame count fent, line count lent, pixel count pent, region code C and interpolation code A (i.e., interpolation codes A(R), A(G) and A(B) respectively for red, green and blue channels) discussed for FIG. 5, the LUT circuit 32 can find a corresponding set of LUT values, which can be transferred to a sum to be added in the adder 26.

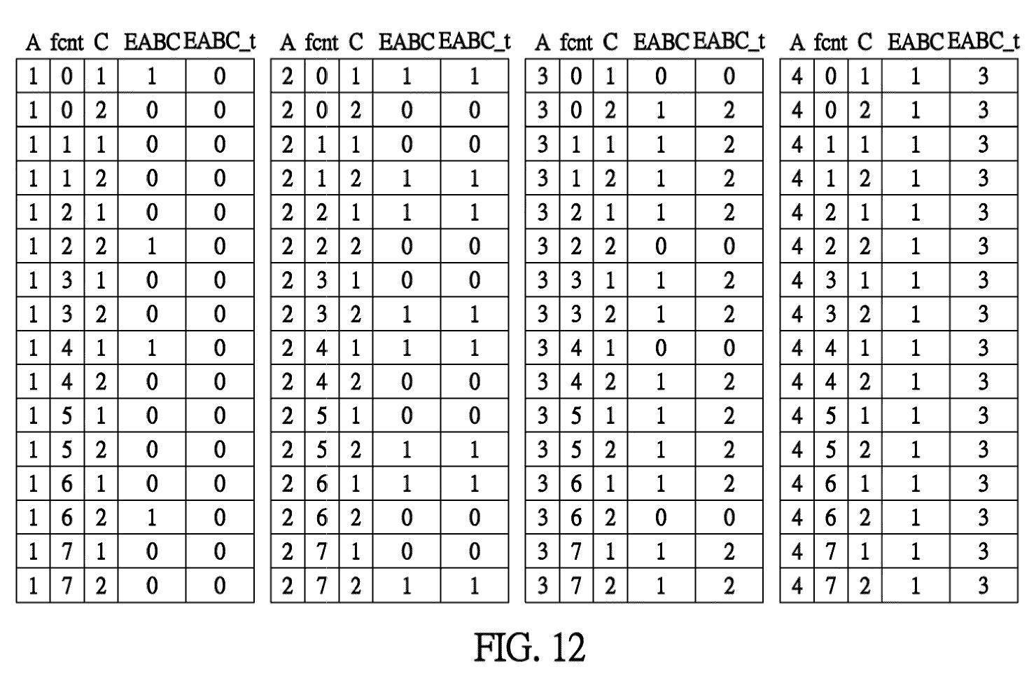

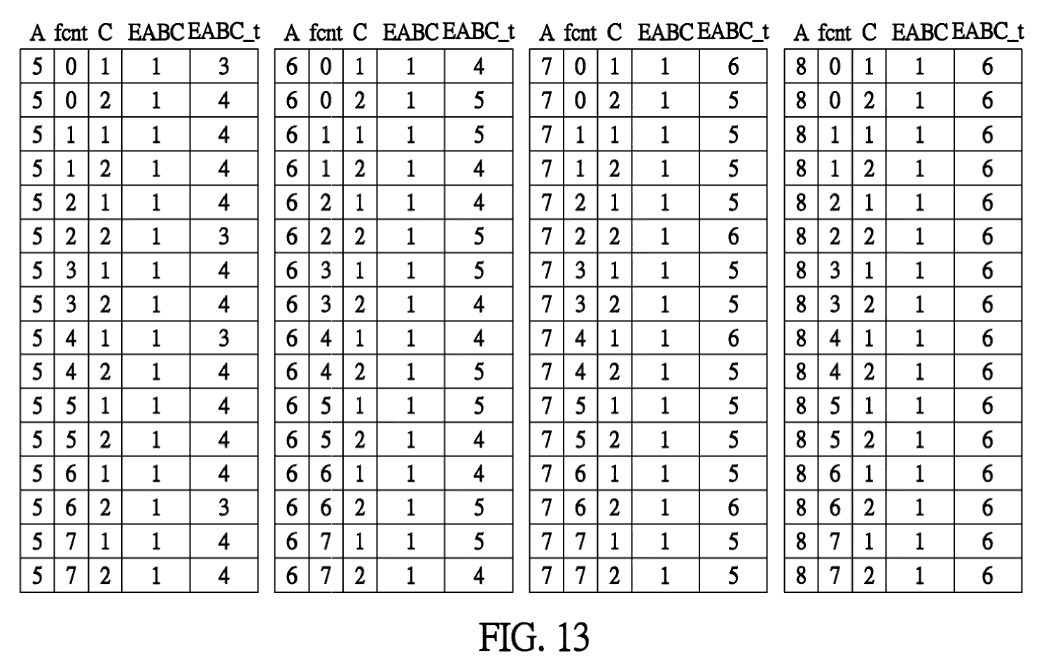

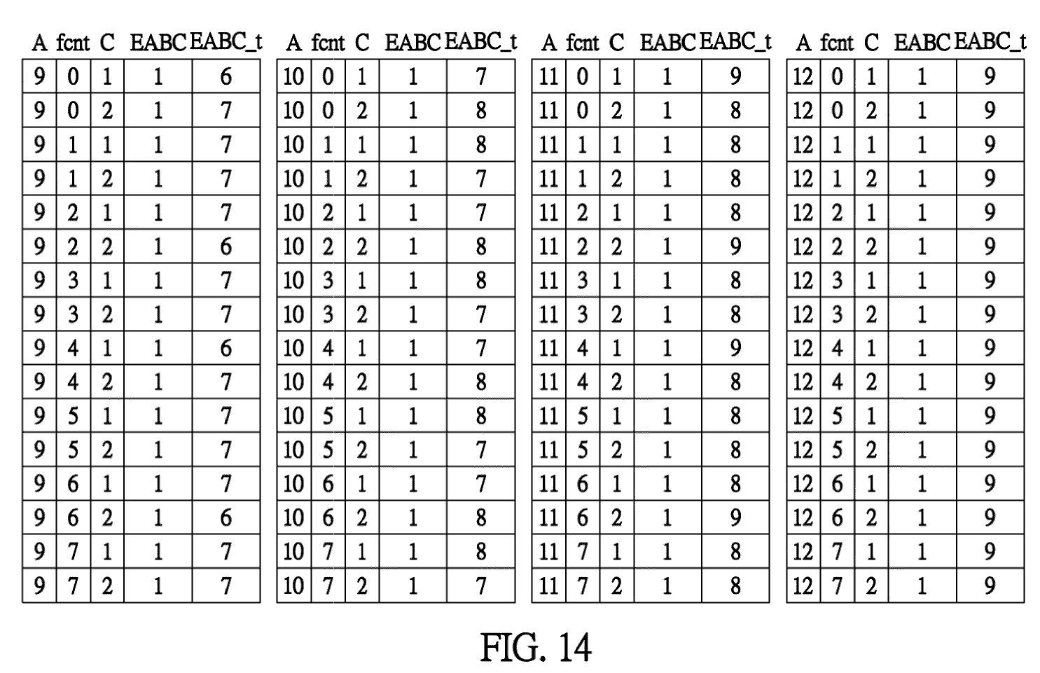

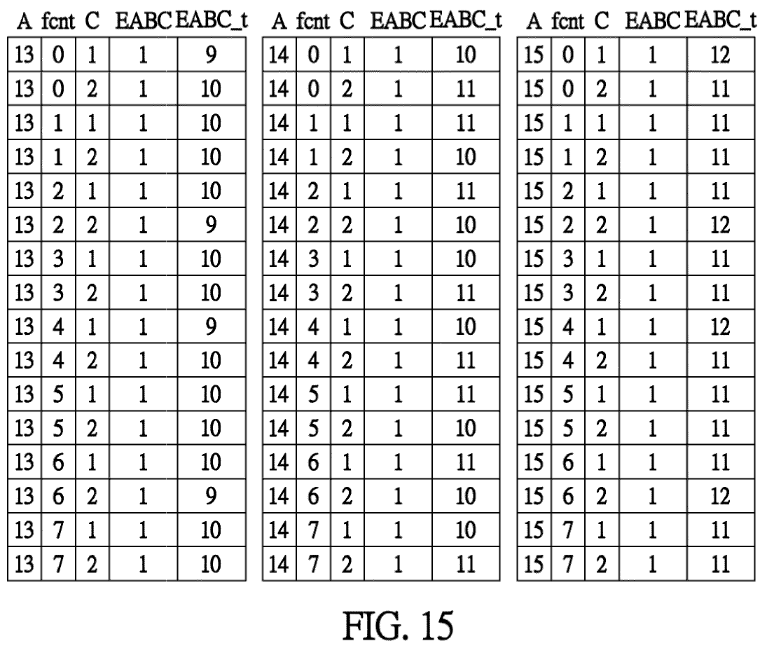

The LUT circuit works as follows. According to corresponding region code C of each pixel, frame count fent of each pixel and interpolation code of each color channel of each pixel, the LUT circuit 32 provides a set of LUT values (EABC, EABC_t) for each color channel of each pixel according to an LUT. FIGS. 12 to 15 abstract a portion of one embodiment of the LUT, wherein the LUT value EABC can be a binary 1-bit value, and the LUT value EABC_t can be a binary 4-bit value (FIGS. 12 to 15 list the LUT values in decimal). The mapping of LUT can be exemplarily described as follows. For example, when interpolation code A is 1, frame count fcnt is 0 and region code C is 1, corresponding set of LUT values (EABC, EABC_t) is (1, 0), as shown in FIG. 12. If the interpolation code A is decimal 12, frame count fent is decimal 6 and region code C is 2, the set of LUT values (EABC, EABC_t) is found to be decimal (1, 9), as listed in FIG. 14.

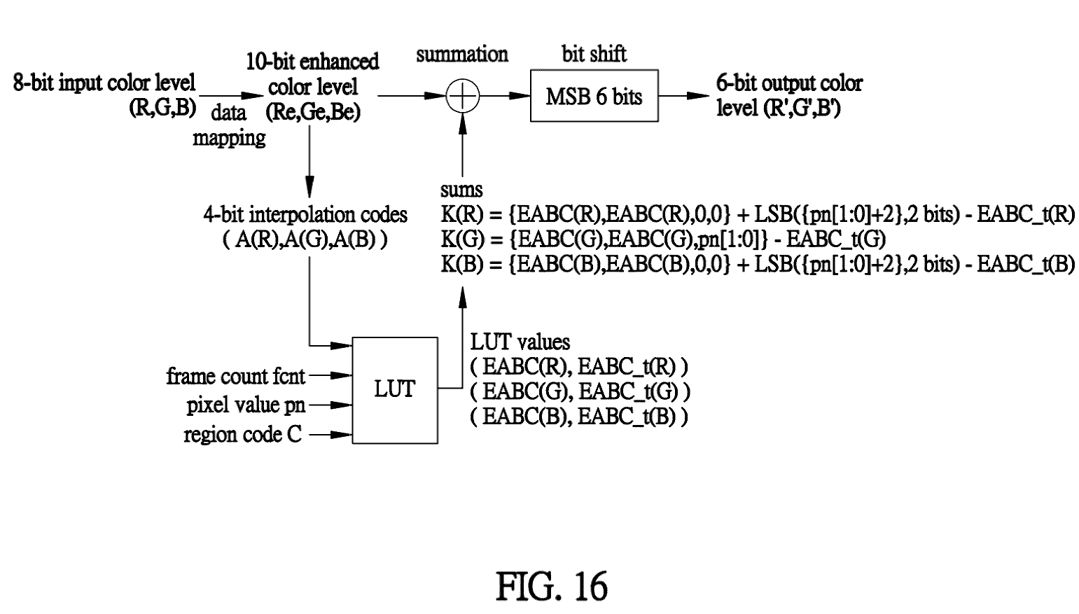

According to LUT values provided by the LUT circuit 32, the adjust circuit 22 can calculate an output color level (R′, G′, B′) for input color level (R, G, B) of each pixel. Please refer to FIG. 16 (and FIG. 5) for further details. FIG. 16 illustrates how the adjust circuit 22 works. As discussed in FIG. 5, input color level (R, G, B) of each pixel is expanded to corresponding enhanced color level (Re, Ge, Be) of higher bit depth by the data mapping circuit 24. For example, 8-bit input color level (R, G, B) can be expanded to 10-bit enhanced color level (Re, Ge, Be) through proper data mapping (or computing). The least significant four bits of each component Re, Ge or Be are extracted to be the interpolation code A(R), A(G) or A(B) respectively for each color channel; that is, the least significant four bits of component Re become interpolation code A(R) for red channel, the least significant four bits of component Ge become corresponding interpolation code A(G) for green channel, etc. According to corresponding frame count fcnt of each pixel, pixel value pn of each pixel, region code of each pixel and interpolation codes (A(R), A(G), A(B)) of each color channel of each pixel, corresponding sets of LUT values (EABC(R), EABC_t(R)), (EABC(G), EABC_t(G)) and (EABC(B), EABC_t(B)) can be found by LUT respectively for red, green and blue channel of each pixel. For green channel, a 4-bit binary sum K(G) is calculated according to corresponding set of LUT values (EABC(G), EABC_t(G)). The sum K(G) of each pixel is obtained by first forming a 4-bit value with most significant two bits duplicating 1-bit LUT value EABC(G) twice and least significant two bit being corresponding pixel value pn, and then subtracting EABC_t(G) from the resultant 4-bit value, as shown in FIG. 16.

For red and blue channels, calculation of the sum K differs slightly. For red channel of each pixel, a 4-bit value is first obtained with its most significant two bits formed by duplicating corresponding 1-bit LUT value EABC(R) and its least significant two bits formed by extracting least significant two bits from a result adding 2 to corresponding pixel value pn of each pixel. Then corresponding LUT value EABC_t(R) is subtracted from this 4-bit value to obtain a sum K(R) for red channel of each pixel, as shown in FIG. 16. The sum K(B) for blue channel of each pixel can be calculated in a similar way also shown in FIG. 16.

By respective adding sums K(R), K(G) and K(B) to corresponding components of enhanced color level (Re, Ge, Be) with the adder 26 (FIG. 5) and then extracting the most significant 6 bits with right shifting of the shifter 28 (FIG. 5), final output color level (R′, G′, B′) for each pixel can be obtained. That is, the most significant 6 bits of (Re+K(R)) are extracted as corresponding 6-bit red channel data R′, the most significant 6 bits of (Ge+K(G)) are extracted as corresponding 6-bit green channel data G′ and the most significant 6 bits of (Be+K(B)) are extracted as corresponding 6-bit green channel data B′. And this resultant 6-bit output color level (R′, G′, B′) can be displayed by the 6-bit display panel 18.

Respective summations of the enhanced color level (Re, Ge, Be) and corresponding sums (K(R), K(G), K(B)) will decide whether the resultant output color level (Re, Ge, Be) are respectively selected from brighter or darker components of displayable color levels. For example, assuming a pixel has a corresponding enhanced color level with a binary green channel component Ge=1101101000, so it has a corresponding interpolation code A(R)=1000. If the pixel has a corresponding pixel value pn=1, frame count fcnt=2 and region code C=1, then it will have a sum K(G)=1101−0110=0111 (binary) for green channel, and the corresponding summation Ge+K(G) is calculated to be binary 1111101011, so the 6-bit green channel data G′ of the final output color is 111110. However, under the same situation but with a pixel value pn=3 (binary 11), then the sum K(G) would change to binary 1111−0110=1001, and resultant summation of Ge+K(G) will become binary 1111110001 with a carry into the fifth bit (as LSB being the first bit). Accordingly, the 6-bit green channel data G′ would be binary 111111. Note that the two 6-bit binary components 111110 and 111111 are displayable (for a 6-bit display), and they are respectively considered as a darker component g0 and a brighter component g1. Form above discussion, it is understood that the sum K(G) of the present invention selects between components g0 and g1 to determine the green channel data of the output color level. Similarly, red or blue channel data of a pixel is selected from displayable red channel components r0 and r1, or blue channel components b0 and b1. Equivalently, whether summation of the 4-bit interpolation code A(R), A(G) or A(B) and corresponding 4-bit sum K(R), K(G) or K(B) has a carry into a fifth bit decides whether a brighter or a darker displayable component is selected as corresponding color channel data of the final output color level according to the present invention.

In other words, to enhance color depth between two 6-bit displayable color levels (r0, g0, b0) and (r1, g1, b1) of a 6-bit display, sums (and corresponding summations) of respective color channels of a pixel will decide which of the displayable color levels (r0, g0, b0), (r0, g0, b1), (r0, g1, b0), (r0, g1, b1), (r1, g0, b0), (r1, g0, b1), (r1, g1, b0) and (r1, g1, b1) is selected as corresponding dithering output color level. Because each sum K integrates spatial dithering pattern (represented by random distribution of pixel value pn) and temporal pattern/order (represented by random order of frame count fcnt), the invention controls dithering order and pattern on a stochastic basis both in temporal and spatial domains, and therefore a softer, smoother and more natural color depth enhancement can be readily achieved.

In aforementioned embodiment, calculation formulae for obtaining sums K(R) and K(B) respectively for red and blue channels are basically the same. Formula of the other sum K(G) for green channel differs slightly. Because red, green and blue channels cause a visual weight 4:6:1, the same formulae for K(R) and K(B) tend to select corresponding red and blue channel components with similar tendency for a same pixel, such as selecting brighter components r1 and b1 for both color channels, or darker components r0 and b0 for both color channels. On the other hand, the different formula of the sum K(G) tends to select corresponding green component with a contrary tendency. For example, if darker red and blue channel components r0 and b0 are selected for a given pixel, there would be a tendency to select a brighter green channel component g1 for that given pixel. On the contrary, if brighter components r1 and b1 are selected for red and blue channels of a pixel, a darker green channel component g0 tends to be selected for that pixel. In this way, selected output color levels (such as (r0, g1, b0) and (r1, g0, b1)) tends to have smaller mutual brightness contrast since total visual weight of blue and red channels approximates visual weight of green channel.

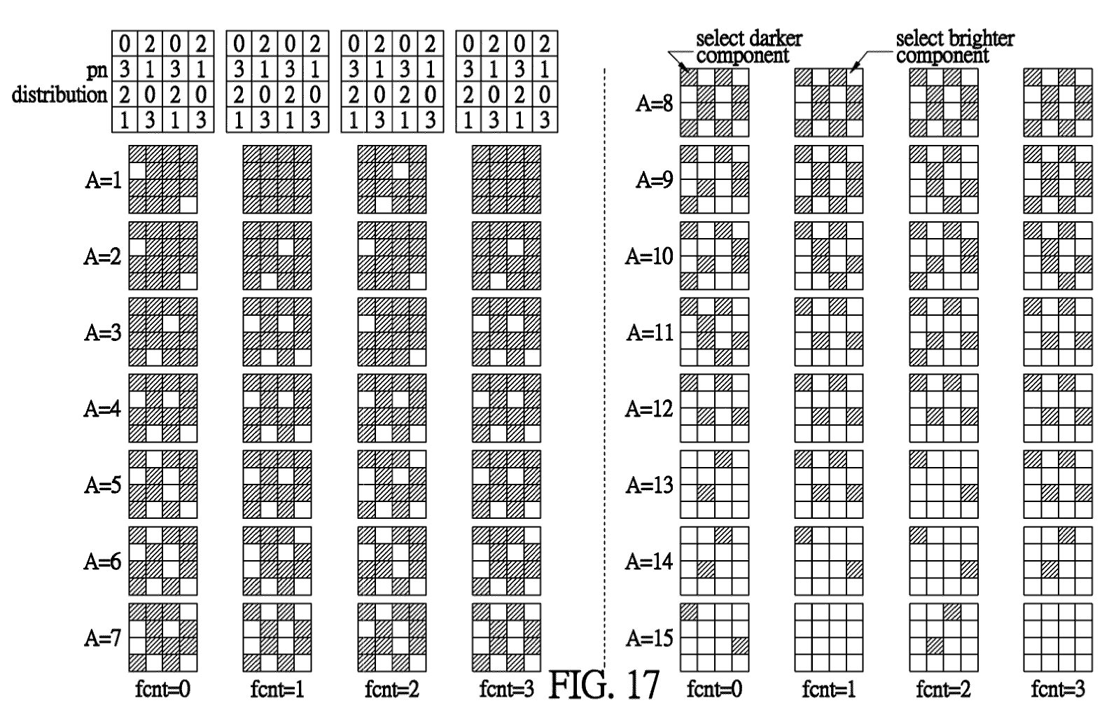

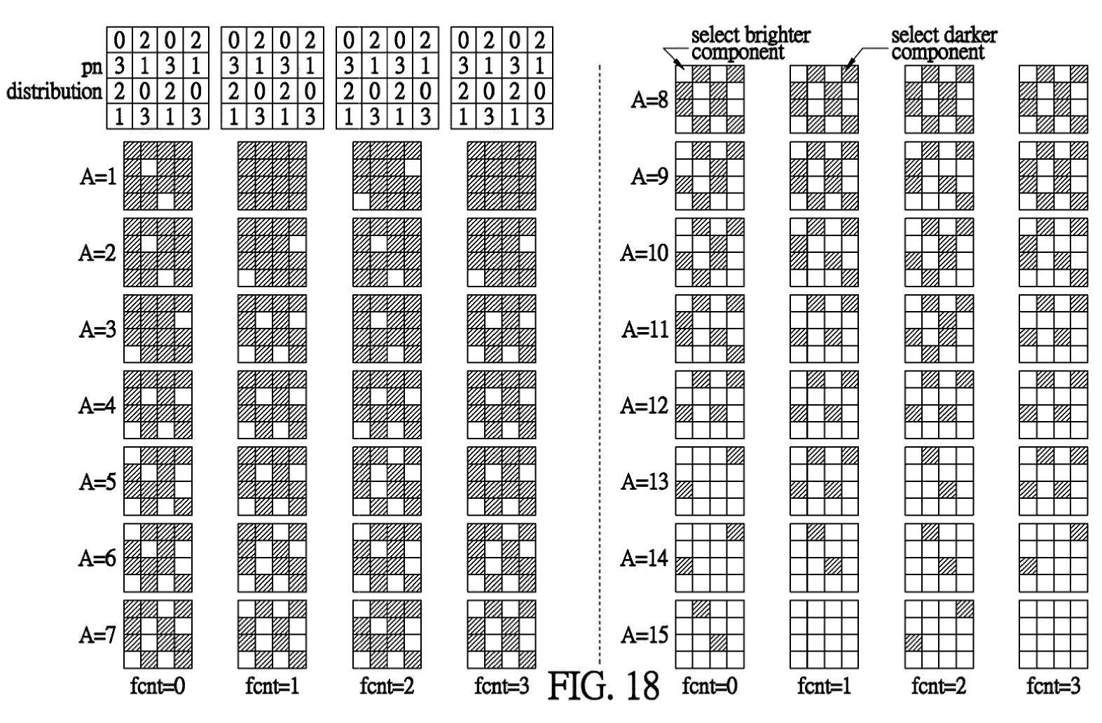

To further describe how the present invention performs color depth enhancement, please refer to FIGS. 17 and 18 which illustrate how pixel values pn, frame counts fcnt and interpolation code A control spatial pattern and temporal order of color dithering for an exemplary block of 4*4 pixels. FIG. 17 shows how green channel data of output color levels are selected. With a given distribution of pixel value pn and a given frame count fcnt, sum K(G) for green channel controls if a darker green channel component or a brighter one is selected. As shown in FIG. 17, when frame count fcnt is 0, if each pixel of the block has an interpolation code A=1, then only two pixels located in second row/first column and fourth row/fourth column will select corresponding brighter displayable green channel components, and other pixels will respectively select corresponding darker displayable green channel components as green channel data of respective output color levels. For the next frame with frame count fcnt=1, all pixels select corresponding darker green components. With such alternating spatial and temporal patterns, an emulated green color component g0+(g1−g0)/16, which is originally not displayable, will be interpolated between two adjacent displayable green components g0 and g1 for each pixel. As another example also shown in FIG. 17, assuming each pixel of the block has an corresponding interpolation code A=14, most pixels (except two pixels) will respectively select corresponding brighter displayable green components, so an dithered green color component g0+14*(g1−g0)/16 is emulated for each pixel by selecting between the two displayable green channel components g0 and g1.

It is also observed in FIG. 17 that pixels with same selection tend to be spread diagonally to avoid direct mutual adjacency through distributions of pixel value pn and region code C (FIG. 10). Region code C is so designed such that blocks of 2*2 pixels with same region code are spread diagonally, as shown in FIG. 11. Though pixel value pn has stochastic nature, continuous (serial) pixel values tend to spread diagonally. As shown in FIG. 17, pixels with serial pixel values 2 and 3 tend to locate in diagonal of a block of 2*2 pixels, thus direct side-by-side adjacency is avoided. Such arrangement design will prevent high local contrast caused by adjacency of pixels with same selection.

Following pixel value distribution and frame count sequence of FIG. 17, FIG. 18 illustrates red/blue channel selection under the same circumstance. As same formulae for sums K(R) and K(B) are applied in this example, red channel component and blue channel component are selected with same tendency. For example, as FIG. 18 shows, when frame count fcnt is 0 and each pixel has an corresponding (red or blue channel) interpolation code A=1, only two pixels located in second row/second column and fourth row/third column select corresponding brighter components for output color level, other pixels will respectively select corresponding darker components. As previously discussed, pixels selecting brighter red/blue channel components are tend to be spread away from pixels selecting brighter green channel components, such that a softer and more natural color dithering can be achieved.

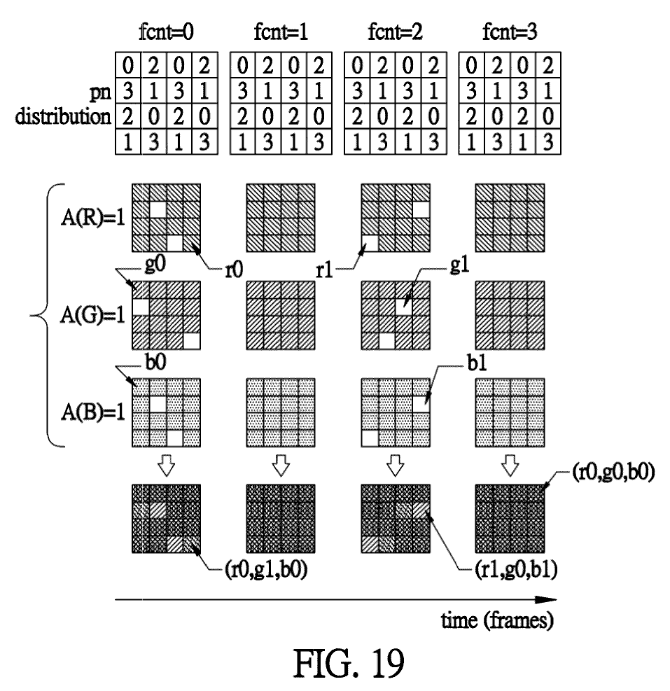

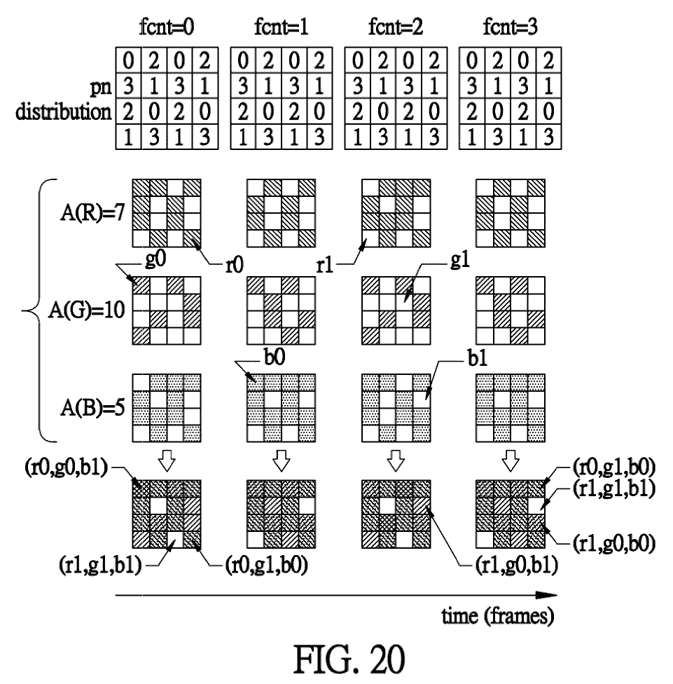

Following the example shown in FIGS. 17 and 18, please refer to FIGS. 19 and 20 which depict two examples showing component selection for all red, green and blue channels according to the invention. In FIG. 19, assuming each pixel has interpolation codes A(R)=1, A(G)=1 and A(B)=1, then selection for each color channel can be found in FIGS. 17 and 18. As shown in FIG. 19, combining selections for green channel (FIG. 17) and red/blue channels (FIG. 18), displayable color levels (r0, g0, b0), (r0, g1, b0) and (r1, g0, b1) are selected as output color levels for color dithering and color depth enhancement. In another example shown in FIG. 20, interpolation codes A(R), A(G) and A(B) of each pixel are assumed to be decimal 7, 10 and 5, respectively. Combining selection made for each color channel of each pixel, displayable color levels (r0, g0, b1), (r1, g1, b1), (r0, g1, b0), (r1, g0, b1), (r0, g1, b0) and (r1, g0, b0) are selected for color depth enhancement.

To sum up, comparing to prior arts, the present invention extracts components from different color channel of different displayable color levels to form output color levels for color dithering, thus a softer and more natural color depth enhancement can be achieved. In addition, alternating color dithering spatial pattern and temporal order with random nature are induced in the present invention, to reduce or avoid flicker and discomfort caused by deterministic regular dithering patterns in spatial and temporal domains. Moreover, the present invention can be implemented with simple, low cost, low power and low layout area architecture of counters, expensive and resource-consuming massive memory for recording dithering pattern and order is then not required, so the present invention can be widely adopted.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for color depth enhancement of a display, the display capable of displaying a plurality of displayable color levels, each displayable color level having a plurality of components with each component corresponding to one of a plurality of color channels, the method comprising:
receiving an input color level having a plurality of data with each data corresponding to one of the plurality of color channels;
selecting a first color channel and a second color channel from the plurality of color channels; and
providing an output color level corresponding to the input color level, the output color level having a plurality of data with each data corresponding to one of the plurality of color channels, wherein if the input color level falls between a first displayable color level and a second displayable color level, a first color channel component of the first displayable color level is assigned to the first color channel data of the output color level, and a second color channel component of the second displayable color level is assigned to the second color channel data of the output color level.

2. The method of claim 1 wherein the plurality of color channels are red, green and blue channels, and while providing the output color level, a green channel component of the first displayable color level is assigned to the green channel data of the output color level, and a red or blue color channel component of the second displayable color channel is assigned to the red or blue color channel data of the output color level.

3. The method of claim 1 further comprising:
displaying the output color level on the display to emulate the input color level.

4. The method of claim 1 further comprising:
receiving a second input color level having a plurality of data with each data corresponding to one of the plurality of color channels;
selecting a third color channel according to the first color channel and the second color channel; and
providing a second output color level corresponding to the second input color level, the second color level having a plurality of data with each data corresponding to one of the plurality of color channels, wherein if the second input color level falls between a third displayable color level and a fourth displayable color level, a third color channel component of the third displayable color level is assigned to the third color channel data of the second output color level.

5. The method of claim 4 wherein the input color level and the second input color level are respective color levels of two neighboring pixels of a frame, and the method further comprises: respectively displaying the output color level and the second output color level on the two neighboring pixels of the frame.

6. The method of claim 4 wherein the input color level and the second input color level are respective color levels of a same pixel of two different frames, and the method further comprises: while displaying the two different frames, respectively displaying the output color level and the second output color level on the pixel of the display.

7. The method of claim 4 further comprising:
selecting a fourth color channel according to the first color channel and the second color channel; and
assigning a fourth color channel component of the fourth displayable color level to the fourth color channel data of the second output color level.

8. The method of claim 7, wherein the third color channel is the second color channel, and the fourth color channel is the first color channel.

9. A method for color enhancement of a display, the display receiving images of different frames and displaying the images with different displayable color levels, each displayable color level having a plurality of components with each component corresponding to one of a plurality of color channels; and each image having a plurality of scan lines with each scan line having a plurality of pixels, each pixel having a corresponding input color level which has a plurality of data with each data corresponding to one of the plurality of color channels; and the method comprising:
while sequentially receiving input color levels of the pixels of the images, providing a pixel value for each pixel according to which scan line each pixel corresponds to and where each pixel locates in corresponding scan line;
providing an LUT (Look-Up Table); and
performing the following for each pixel:
according to the input color level of the pixel, selecting a first color level and a second color level among the displayable color levels;
according to the LUT and the pixel value of the pixel, selecting a first color channel and a second color channel; and
providing an output color level for the pixel which has a plurality of data with each data corresponding to one of the plurality of color channels, wherein the first color channel component of the first color level is assigned to the first color channel data of the output color level and the second color channel component of the second color level is assigned to the second color channel data of the output color level.

10. The method of claim 9 wherein providing the pixel value for each pixel comprises:
proving a corresponding line count for each pixel by counting which scan line each pixel corresponds to;
providing a corresponding line value for each pixel according to the line count of each pixel; and
providing the pixel value for each pixel according to the line value and a pixel count of each pixel.

11. The method of claim 10 wherein providing the line value for each pixel according to the line count of each pixel comprises:
if the line count matches a predetermined condition, assigning a stochastically generated random number to the line value.

12. The method of claim 10 further comprising:
providing the pixel count for each pixel according to where each pixel locates in corresponding scan line;
providing a region code for each pixel according to corresponding line count and pixel count of each pixel;
providing a frame count for each pixel according to which frame each pixel corresponds to while sequentially receiving the images; and
calculating an interpolation code for each color channel of each pixel according to corresponding input color level of each pixel;
wherein proving the LUT comprises providing LUT values respectively corresponding to different frame counts, different region codes and different interpolation codes.

13. The method of claim 12, wherein providing the frame count for each pixel comprises:
providing a period count for each pixel according to which frame each pixel corresponds to; and
if the period count match a predetermined condition, assigning a stochastically generated random number to the period count.

14. The method of claim 12, wherein selecting the first color channel and the second color channel for each pixel comprises:
finding a corresponding LUT value for each color channel of each pixel according to corresponding frame count of each pixel, corresponding region code of each pixel and corresponding interpolation code of each color channel of each pixel; and
providing a corresponding sum for each color channel of each pixel according to corresponding pixel value of each pixel and corresponding LUT value of each color channel of each pixel; and
selecting the first color channel and the second color channel for each pixel according to summations respectively summing corresponding sum and interpolation code of each color channel of each pixel.

15. A color enhancement circuit for a display, the display receiving images of different frames and displaying the images with different displayable color levels, each displayable color level having a plurality of components with each component corresponding to one of a plurality of color channels; and each image having a plurality of scan lines with each scan line having a plurality of pixels, each pixel having a corresponding input color level which has a plurality of data with each data corresponding to one of the plurality of color channels; the color enhancement circuit comprising:
a spatial pattern generator for providing a pixel value for each pixel according to which scan line each pixel corresponds to and where each pixel locates in corresponding scan line while sequentially receiving input color levels of each pixel of the images;
an LUT circuit for providing an LUT (Look-Up Table); and
an adjust circuit for selecting a first color level and a second color level among the displayable color levels for each pixel according to the input color level of each pixel, selecting a first color channel and a second color channel for each pixel according to the LUT and corresponding pixel value of each pixel, and providing an output color level for each pixel which has a plurality of data with each data corresponding to one of the plurality of color channels, such that the first color channel component of the first color level is assigned to the first color channel data of the output color level and the second color channel component of the second color level is assigned to the second color channel data of the output color level.

16. The color enhancement circuit of claim 15, wherein the spatial pattern generator comprises:
a line counter for providing a line count for each pixel by counting which scan line each pixel corresponds to;
a pixel counter for providing a pixel count for each pixel by counting where each pixel locates in corresponding scan line;
a line value circuit for providing a line value for each pixel according to corresponding line count of each pixel; and
a pixel value circuit for generating corresponding pixel value for each pixel according to corresponding line value and pixel count of each pixel.

17. The color enhancement circuit of claim 16 wherein the spatial pattern generator further comprises:
a random number generator for stochastically generating a random number as corresponding line value of each pixel if corresponding line count of each pixel matches a predetermined condition.

18. The color enhancement circuit of claim 16 wherein the spatial pattern generator further provides a region code for each pixel according to corresponding line count and pixel count of each pixel, and the spatial pattern generator further comprises:
a frame counter for providing a frame count for each pixel according to which frame each pixel corresponds to;
and the adjust circuit comprises:
a data mapping circuit for providing an interpolation code for each color channel of each pixel according to corresponding input color level of each pixel; and
wherein the LUT circuit provides LUT values respectively corresponding to different frame counts, different region codes and different interpolation codes.

19. The color enhancement circuit of claim 18, wherein the spatial pattern generator further comprises:
a period counter for providing a period count for each pixel according to which frame each pixel corresponds to; and
a random number generator for stochastically generating a random number as corresponding frame count of each pixel when corresponding period count of each pixel matches a predetermined condition.

20. The color enhancement circuit of claim 18 wherein the LUT circuit finds a corresponding LUT value for each color channel of each pixel according to corresponding frame count of each pixel, region code of each pixel and interpolation code of each color channel of each pixel, and provides a sum for each color channel of each pixel according to corresponding pixel value and LUT value of each color channel of each pixel; and the adjust circuit further comprises:
an adder for summing corresponding sum and interpolation code of each color channel of each pixel such that the adjust circuit can accordingly select corresponding first color channel, second color channel, first color level and second color level for each pixel.
